(19) United States
(12) Patent Application Publication
(10) Pub. No.: US 2008/0133496 A1
(43) Pub. Date: Jun. 5, 2008

(54) METHOD, COMPUTER PROGRAM PRODUCT, AND DEVICE FOR CONDUCTING A MULTI-CRITERIA SIMILARITY SEARCH

(75) Inventors: Tapas Kanungo, San Jose, CA (US); Robert Krauthgamer, Albany, CA (US); James J. Rhodes, Los Gatos, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/565,748

(22) Filed: Dec. 1, 2006

(51) Int. Cl. G06F 17/30

(52) U.S. Cl. 707/5; 707/E17.036

(57) ABSTRACT

Similarities among multiple near-neighbor objects are searched for based on multiple criteria. A query is received for an object closest to an object provided by a user, and weights are assigned by a user to distance functions among the multiple objects at the time of the query. Each distance function represents a different criterion. The weighted average is calculated for the distance functions, and the closest object to the query object based on the weighted average for the distance functions.

### FIELD OF INVENTION

This application relates to similarity searching, more particularly to multi-criteria similarity searching.

### BACKGROUND OF INVENTION

Searching a database for items or objects having similar attributes is crucial in many real-world tasks. The relative importance of item attributes can often vary significantly from user to user, and even from task to task. However, current approaches to similarity searching cannot take full advantage of the user-specified relative importance of attributes. Computational efficiency or accuracy must be sacrificed.

In practice, similarity search algorithms account for the relative importance only in a post processing phase. First, a short list of similar items is found based on some fixed distance metric, and then the items in the short list are ranked according to the user-specified weights. These approaches work reasonably well when the relative weights are not very different. Otherwise, the algorithm might end up post-processing a large set of items, potentially the entire dataset. In fact, there seems to be no principled approach for selecting items to be post processed according to user-specified weights.

As a specific example, consider the drug discovery problem of finding a replacement molecule for fluoro alkane sulfonic acid (CF₃CF₂SO₃H). This molecule appears in everyday products like Scotchgard™, floor wax, and Teflon®, and in electronic chip manufacturing materials, like photoresists, etc. The problem is that this molecule is a bioaccumulator and is a potential carcinogen (a substance that causes cancer). Furthermore, it has made its way through the food chain, and can now be found in even polar bears and penguins. Companies are proactively trying to replace this acid with other, more environmentally friendly molecules. The sulfonic acid fragment SO₃H is the critically necessary element. The harmful fragment is anything that looks like CF₃(CF₂)ₙ. The problem then is to find molecules that have the SO₃H fragment, and perhaps a benzene ring which would allow the synthetic chemist to replace an alkyl group with something that accounts for the electron withdrawing property of CF₃CF₂. It would be ideal for the chemist to look for a candidate molecule based on its similarity to the molecular formula of the fragment, the structure of the benzene, or some weighted combination of both.

A common model for a similarity search is to represent data items as points in a metric space, such that distances serve as a measure of dissimilarity. This model, commonly referred to as a “Near-Neighbor” search approach, has a major limitation in that it is applicable only to certain similarity notions, since distances must satisfy the triangle inequality; i.e., the concept that going between two points through a third point is never shorter than going directly between two points. This is not the case in many real-life scenarios, because there could be a data item Y which is similar to two data items X and Z that are not similar to each other.

Near neighbor searching in Euclidean and l₁ metrics has been studied extensively. The low-dimensional case (say, fixed dimension) has been solved quite well. However, the running times of these algorithms grow exponentially with the dimension d, a phenomenon often called the “curse of dimensionality”.

Locality-Sensitive Hashing (LSH) has been introduced to improve nearest neighbor searching. While LSH improves the query running time of nearest neighbor searching, it requires additional time and storage to preprocess the data items and build an index.

A closely related problem is rank aggregation, where every object in a database has m attributes (scores), and the goal is to find the top k objects according to some aggregate function of the attributes (usually a monotone function, such as minimum or average). In this problem, access to the database is limited to (i) sorted access—for every attribute there is a sorted stream in which all the objects are sorted by that attribute; and (ii) random access—requesting an attribute value of an object. Rank aggregation has been used to perform near neighbor searching in a Euclidean metric. However, rank aggregation has a very restricted access to objects, and thus there are cases in which no aggregation algorithm can succeed in a runtime that is sublinear in the number of objects.

Accordingly, there is a need for a technique for a similarity search that takes into account multiple criteria, including user input regarding the weights, to determine similarity.

### SUMMARY OF INVENTION

According to exemplary embodiments, a method, computer program product, and device are provided for searching for similarities among multiple near-neighbor objects based on multiple criteria. A query is received for an object closest to a query object, and weights are assigned by a user to distance functions among the multiple objects at the time of the query. Each distance function represents a different criterion. The weighted average is calculated for the distance functions, and the closest object to the query object is determined based on the weighted average for the distance functions.

According to exemplary embodiments, the objects are indexed and represented as high-dimensional feature vectors, and each distance function is a metric on a subset of features. In response to receiving the query for an object with weights assigned to distance functions, a weight vector is found that is close to the object, and a hash function is retrieved corresponding to the weight vector. The closest object to the query object is determined by determining the object that is closest to the objects within a given distance based on a hashing process using the retrieved hash function. The user-specified weights affect the selectivity of the features used in the hashing process. The more weight a user specifies for a specific feature, the more likely that feature is to be selected in the hashing process.

Additional features and advantages are realized through the techniques of the present invention. Other embodiments and aspects of the invention are described in detail herein and are considered a part of the claimed subject mattern. For a better understanding of the invention with advantages and features, refer to the description and to the drawings.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrate an exemplary compound and its InChI description.

FIGS. 2a and 2b illustrate the profile of three normalized distance functions.

FIG. 3 illustrates an average run-time of multi criteria LSH for different preprocessing weights and varying numbers of indexes.

FIG. 4 illustrates a standard LSH.

FIGS. 5a-5c illustrate average error of K-NNS for given query weights and different weight vectors.

FIG. 6 illustrates a 90-percentile error of multi criteria LSH for different preprocessing weights and varying numbers of indices.

FIG. 7 illustrates an average error of multi criteria LSH for different query weights and varying numbers of indices.

FIG. 8 illustrates a method for conducting a multi-criteria similarity search according to an exemplary embodiment.

FIG. 9 illustrates an exemplary device for conducting a multi-criteria similarity search according to an exemplary embodiment.

The detailed description explains exemplary embodiments of the invention, together with advantages and features, by way of example with reference to the drawings.

### DETAILED DESCRIPTION OF EMBODIMENTS

According to exemplary embodiments, a technique for conducting a similarity search is provided that is applicable to many real-life scenarios. The technique involves considering a multi-criteria near-neighbor search problem in which the dissimilarity between data items is measured by a weighted average of several distance functions, each representing a different criterion. The weights of the different criteria can vary arbitrarily and are given by the user as part of the search during a query stage. The weights are thus unknown when the database is indexed at the preprocessing stage. For example, if objects, e.g., chemicals, X and Y are similar with respect to one characteristic (e.g., chemical formula), and objects Y and Z are similar with respect to another characteristic (e.g., structure), then clearly X and Z need not be similar at all.

According to an exemplary embodiment, an indexing scheme is provided that efficiently solves this type of multi-criteria search when data is given as high-dimensional feature vectors. Each distance function is an L_{—}1 metric on a subset of the features. This more general paradigm can capture richer semantics of similarity than the conventional dissimilarity search approaches.

According to exemplary embodiments, user-specified attribute weights, which can be used to increase or decrease the selectivity of different attributes, may be used. This technique provides very strong performance guarantees.

As in an illustrative example, consider a chemical search, which has been traditionally modeled as follows. Each molecule or drug is represented as a very high-dimensional vector, where a dimension (attribute) could represent a certain fact, e.g., the number of hydrogen atoms, the number of hydrogen-carbon bonds, the atom connectivity information, etc.

According to an exemplary embodiment, a technique is provided that extracts attribute values from a new open standard for representing molecules, called IUPAC International Chemical Identifier (InChI), described in more detail below. The InChI representation is unique in the sense that the encoding scheme prevents the creation of two InChI representations for the same molecule. Also, this representation is split into layers, where each layer encodes some aspect of the molecule. For example, the first layer encodes the chemical formula, the second layer encodes the connection (graph) structure of the molecule, and the third layer encodes the bonding structure of the hydrogen atoms. These layers form a natural set of criteria for selecting or weighting during a similarity search process.

According to an exemplary embodiment, a more general paradigm is used than that traditionally used. To understand the paradigm presented in this disclosure it is helpful to review previous approaches to similarity searching, beginning with the nearest neighbor search (NNS).

Denoting the set of all possible points (data items) by X, and letting [symbol] ⊂X denote the collection of n points given to the algorithm as input (for preprocessing), then n=| [symbol] |, while X may be of infinite size and it contains, in particular, all possible queries. Given this notation, a Nearest Neighbor Search (NNS) may be defined as follows: Given a set [symbol] X of size n, [symbol] is preprocessed so as to efficiently answer queries given as a point q∈X, by finding a point in S that is closest to q under the distance D.

The context is the point set X mentioned above and a distance D(∵) between every two points in X. The distance function that represents criterion j∈{1, . . . , m} may be denoted by Dⱼ(∵). Thus, there are m distance functions that are all defined on the same point set X.

A vector w∈ [symbol] ^{m} may be called a weight vector if all its coordinates are nonnegative. Often, it will be convenient to assume that

$${\sum }_{j = 1}^{m} {w}_{j} = 1.$$

Given a weight vector w, the weighted distance (or overall distance) between two items x and y is:

$${D}^{w} ( x , y ) = {\sum }_{j = 1}^{m} {w}_{j} \cdot {D}_{j} ( x , y ) . \qquad ( 1 )$$

An important special case is where each distance function Dⱼ(∵) is a l₁ metric, For example, if x is a d-dimensional vector in [symbol] ^{d}, each Dⱼ(∵) may be the l₁ metric over a group of distinct d/m coordinates. More generally, for 1=d₁<d₂< . . . <dₘ₊₁=d+1, the jth criterion may be defined to be the l₁ metric over coordinates d₁, . . . , dⱼ₊₁−1. Furthermore, each distance function D^{j}(∵) may be normalized by a suitable scaling factor Rⱼ>0, as distances in different criteria may vary drastically (e.g., due to the very different dimensions in each criterion). In this case, the distance function Dⱼ(∵) may be given as:

$${D}_{j} ( x , y ) = \frac{1}{{R}_{j}} {\sum }_{i = {d}_{j}}^{{d}_{j + 1} - 1} \vert {x}_{i} - {y}_{i} \vert . \qquad ( 2 )$$

The weights may be used in alternative ways, such as

$${D}^{w} ( x , y ) = {( {\sum }_{j = 1}^{m} {w}_{j} \cdot {{D}_{j} ( x , y )}^{2} )}^{1 / 2} ,$$

which may be particularly appropriate in the case where the distance functions Dⱼ(∵) are all l₂ metrics.

Building on the concepts above, the Multi-Criteria Nearest Neighbor Search (MC-NNS) may then be defined as follows. Given a set S [symbol] X of size n, the set [symbol] may be preprocessed so as to efficiently answer queries, given as a point q∈X and a weight vector w, by finding a point in [symbol] that is closest to q under the distance D^{w}. The context is, as mentioned above, the point set X and the m distance functions D^{j}(∵). This definition naturally generalizes to the case where K>1 points are reported that are closest to the query. D(q, [symbol] ′) may be defined as the distance of q to its closest point in [symbol] ′, i.e., D(q, [symbol] ′)=_{minS′}D(q,z).

Now, given a set [symbol] X of size n, the (1+ε) Approximate Multi-Criteria Nearest Neighbor Search may be defined by preprocessing [symbol] so as to efficiently answer queries, given as a point q∈X and a weight vector w, by finding a point α∈ [symbol] such that D^{w}(q,α)≦(1+ε)D^{w}(q, [symbol] ). The definition also naturally generalizes to the case where K>1 points are reported that are closest to the query. The jth point reported by the algorithm is simply compared with the jth nearest point to the query.

As explained below, a weight vector w can be substituted with a “close by” vector w′, at the cost of increasing the approximation guarantee. The vector w′ may then be used to reduce multi-criteria NNS to standard NNS, by limiting the number of different weight vectors needed for the purpose of approximate nearest neighbor searching.

To replace a weight vector w with a close by vector w′, one may start with the following simple proposition. Let w and w′ be two weight vectors in [symbol] ^{m}, and let δ>0 be such that w′ⱼ≦(1+δ)wⱼ for all j=1, . . . , m. Then, for all x,y∈X.

D^{w′}(x,y)≦(1+δ)D^{w}(x,y). (3)

Now, let w and w′ be two weight vectors in [symbol] ^{m}, and let δ>0 be such that:

$$\frac{1}{1 + δ} \leq \frac{{w}_{j}}{{w}_{j}^{′}} \leq 1 + δ for all j = 1 , … , m \qquad ( 4 )$$

### Then, a (1+ε)—approximate nearest neighbor under D^{w′} is a (1+ε)(1+δ)²—approximate nearest neighbor under D^{w}.

Using the proposition above:

D^{w}(q,α)≦(1+δ)D^{w′}(q,α)/ (5)

and also

D^{w}(q,X)≦(1+δ)D^{w}(q,X). (6)

Now, going from Multi-Criteria to Standard NNS, a general solution would be to “discretize” the space of all weight vectors to within accuracy 1+δ, namely, to prepare in advance a collection W of weight vectors such that for every weight vector w there is w′∈Ŵ with 1/(1+δ)≦wⱼ/w′ⱼ≦1+δ. The problem can then be reduced to the standard (i.e., single-criterion) near-neighbor search, as follows. At the preprocessing stage, w′∈Ŵ is executed for every standard near-neighbor searching using distance function D^{w′}. At query time, the weight w′∈Ŵ is found that is closest to the input weight w, and the standard near-neighbor search is applied using this weight w′.

In practice, the weight vector can be restricted, such that each wⱼ is either zero or at least α>0. In this case, it suffices to consider only

$$1 + ⌈ {log}_{1 + δ} ( 1 / α ) ⌉ = O ( \frac{log 1 / α}{log 1 + δ} )$$

different values for each wⱼ. Consequently, the size of Ŵ is upper bounded by

$${[ O ( \frac{log 1 / α}{log 1 + δ} ) ]}^{m} .$$

An efficient scheme for the approximate multi-criteria NNS problem in l₁ uses hashing. Those skilled in the art will be familiar with hashing processes. However, for details regarding hashing, the reader is directed to “Similarity Search in High Dimensions via Hashing”, by A. Goinis et al., Proceedings of the 25^{th} International Conference on Very Large Data Bases, pp 518-529, 1999. To simplify the discussion, the following assumptions may be made in the data (without substantial loss of generality). For each criterion j=1, . . . , m, the distance function Dⱼ(∵) is defined by the l₁ norm, using only 0-1 coordinates for each point, scaled by a factor of Rⱼ. Also, it may be assumed that the overall distance is a weighted l₁ norm, i.e., the weighted sum of distances in each criterion.

Now, for Multi-Criteria NNS via Hashing, recall that the input for the preprocessing algorithm is a set [symbol] X of n points and that the inputs for the query algorithm include a point q∈X and a weight vector w∈ [symbol] ^{m}. These algorithms use a parameter B, representing an upper bound on the number of points that would be desirable to retrieve in a single access to external storage (disk). There are also two integer parameters k and l, the values of which may be determined as described below.

As part of preprocessing, first, a collection Ŵ of weights w′ is determined that can approximate within a factor 1+δ every weight vector w that may possibly come up at query time. It can be assumed that the weight vector is restricted, for some parameter α>0, to the set W_{α} of weight vectors, such that for all j=1, . . . , m, either wⱼ=0 or wⱼ≧α. Then, a set W′ may be constructed that approximates W within a factor 1+δ in the sense that for every w∈W, there is w′∈W′, such that for all j=1, . . . , m.

$$\frac{1}{1 + δ} \leq \frac{{w}_{j}}{{w}_{j}^{′}} \leq 1 + δ . \qquad ( 7 )$$

It is not difficult to do this with

$$\vert {W}^{′} \vert \leq {[ O ( \frac{log 1 / α}{log 1 + δ} ) ]}^{m} .$$

### However, in contrast to the “discretizing” solution described above, the query procedure will eventually report the point that is closest to q under D^{w} for the queried weight vector w (from a certain set of candidate points).

Next, for each w′∈W′, l hash functions are constructed, where each hash function may be constructed independently at random as follows. A multiset I of coordinates is chosen at random and independently from {1, . . . , d}, by repeatedly picking a random coordinate, such that the probability of picking coordinate i∈{1, . . . , d} that belongs to the group j criterion (i.e., dⱼ≦i≦dⱼ₊₁−1) is proportional to vᵢ=wᵢ/Rⱼ. That is, coordinate i is picked with probability

$${v}_{i} / {\sum }_{i = 1}^{d} {v}_{i} .$$

This may be repeated k times, such that |l|=k. Now, the hash function is simply a projection on the coordinates of l, i.e., the hash function for l={iⱼ, . . . , iₖ} is x [symbol] (xᵢ_{₁}, . . . , xᵢ_{ₖ}). The l random hash functions constructed this way may be denoted by h_{w′,1}, . . . , h_{w′,j}.

For each w′∈W′ and each t=1, . . . , l a hash table comprising the tuples (x,h_{w′j}(x)) may be constructed for all x∈ [symbol] . The bucket of b may be the set of all points x∈ [symbol] with hashes equaling b, i.e., {x∈ [symbol] :h_{w′j}(x)=b}. In order to provide a quick access to the buckets in this table, the table may be indexed by its second column. A method that may be used to implement this table is to use standard hashing (i.e., another level of hashing may be used on top of h_{w′j}). The size of each such table is clearly much larger than |S|=n, although an efficient implementation of it using a second level hashing can reduce the storage requirement to O(n). Note that the total number of such tables is l·|W′|.

To process a query q with weight w, a weight vector w′∈W′ may first be found that is close in the sense of Equation 7. For each t=1, . . . , l, the bucket of h_{w′j}(q) may be retrieved from the table corresponding to w′and t. To guarantee efficiency, only the first 4B points from each such bucket are retrieved, denoting this set of points by Xᵢ. Clearly, the number of disk accesses is upper bounded by l, each one being a sequential read of at most O(B) points.

Processing the query in this fashion results in reporting the points that is closest to q under the distance D^{w} among all the points that are retrieved from the t buckets, i.e., among ∪ᵢ₌₁^{l}Xₗ. For an approximate K-NNS, the K closest points to q would be reported. Fewer points (or no points at all) may be reported if the corresponding buckets turn out to be empty.

Now considering locality sensitive hashing, consider the following definition, where D(∵) is an arbitrary distance function unless stated otherwise. A family H of functions from X to U is called (r₁,r₂,p₁,p₂)-sensitive for a distance function D(∵) if, for all x,y∈X:

if D(x,y)≦r₁ then Pr_{heR}[h(x)=h(y)]≧p₁.

if D(x,y)≦r₂ then Pr_{heR}[h(x)=h(y)]≦p₂.

This definition is useful if r₁<r₂ and p₁>p₂. It is easy to verify that for the Hamming distance, the family of projections on one coordinate is locality sensitive. This is described more detail below.

Given a family H of functions from X to U, let the family H^{k} comprise all functions g:X [symbol] U^{k} formed by a concatenation of k functions h₁, . . . , hₖ∈H, i.e. g(x)=(h₁(x), . . . , hₖ(x)). Now, let H be an (r₁,r₂,p₁,p₂)-sensitive family for D(∵), and let k>0 by an integer. Then, the family H^{k} is (r₁,r₂,p₁^{k},p₂^{k})-sensitive for D(45). Let B represent an upper bound on the number of points that would like to be retrieved in a single access to external storage (disk), and let r>0 and ε>0 be given at preprocessing time. Given an (r₁,r₂,p₁,p₂)-sensitive family for D(∵),

$$ρ = \frac{ln {p}_{1}}{ln {p}_{2}}$$

may be defined, and k may be set to equal

$$\frac{ln ( B / n )}{in {p}_{2}} ,$$

such that

p₂^{k}=B/n, p₁^{k}=(B/n)^{p}. (8)

Based on this value of p₂^{k}, it can be argued that with probability of at least 1/2, that a bucket contains not too many points at a distance of at least r₂. Setting l=1/p₁^{k}=(n/B)^{p}, it can be argued that with probability of at most 1/e, that in at least one of the l hash tables, the respective bucket will contain a point within a distance of at most r₁. This analysis can be summarized as follows.

For a given r, ε and B, let H be an (r₁,r₂,p₁,p₂)-sensitive family for D(∵), and let p,k,l be set as above. Then, for every set [symbol] ⊂X of size n and every query q∈X, a random sample of l functions h₁, . . . , hₗ from H^{k} satisfies with probability of at least

$$\frac{1}{2} - \frac{1}{e} \geq 0.132$$

both of the following two properties: if there is α∈ [symbol] with D(q,α)≦r, then there is t∈{1, . . . , l} for which hₗ(q)=hₗ(α); and the buckets h₁(q), . . . , hₗ(q) have total size at most 4l·B.

Now, turning attention to l₁ metrics, for i32 1, . . . , d, then h₁ᵢ:X [symbol] U may be defined to be the projection on coordinate i, i.e., h₁ᵢ(x)=xᵢ. Letting X={0,1}^{d} be the d-dimensional cube equipped with the Hamming metric

$$D ( x , y ) = {\sum }_{j = 1}^{d} \vert {x}_{j} - {y}_{j} \vert ,$$

then for every r,ε>0, the family H={₁ᵢ, . . . , h_{1d}} is

$$( r , r ( 1 + ɛ ) , 1 - \frac{r}{d} , 1 - \frac{r ( 1 + ɛ )}{d} ) \sim$$

sensitive.

Using this choice of parameters, namely

$${p}_{1} = 1 - \frac{r}{d} and {p}_{2} = 1 - \frac{r ( 1 + ɛ )}{d} ,$$

for r<d/ln n (which is easily achieved by padding zeros) then

$$ρ \leq \frac{1}{1 + ɛ} .$$

### This results in a query algorithm having a sublinear running time of ((l·B)=O(n^{p}B^{1-p}).

It should be noted that the family H as defined above may be seen as a distribution of hash functions. Specifically, one can associate to every function h∈H a weight wₕ. Then, a random function from H may be chosen by choosing each h∈H with a probability proportional to its weight wₕ. Recall that h₁ᵢ:X [symbol] U was defined to be the projection on coordinate i, i.e., h₁ᵢ(x)=xᵢ.

Letting X={0,1}^{d} be the d-dimensional cube equipped with the weighted metric D^{w}(x,y) given by Equations (1)-(2) and letting the family H^{w} containing each function hᵢ with weight vᵢ=wᵢ/Rⱼ, then for every r,ε>0, the family

$${H}^{w} is ( r , r ( 1 + ɛ ) , 1 - \frac{r}{d} , 1 - \frac{r ( 1 + ɛ )}{d} ) \sim$$

sensitive, where

$${d}^{′} = {\sum }_{i = 1}^{d} {v}_{i} .$$

### Using this hash family H^{w}, the query algorithm can be generalized to the weighted case and have the same bounds on its performance, namely a sublinear running time for the query algorithm.

According to an exemplary embodiment, a significant difference between the query algorithm for Multi-Criteria NNS and the generalization of query algorithm that results from the discussion above is that the query described above uses a weight vector w at its final reporting step, while the preprocessing (and the LSH technique) according to an exemplary embodiment uses a weight vector w′. Recalling the analysis above, if the query algorithm were to report the point (among all the retrieved buckets) that is closest to q under the distance D^{w′}, then it would achieve an approximation guarantee of (1+ε) with respect to this distance. Reporting this exact same point achieves an approximation guarantee of (1+ε)(1+δ)² with respect to the distance D^{w}. Clearly, reporting the best point under D^{w} can only perform better, and is expected to do so in practice.

The algorithm described above, according to an exemplary embodiment, solves a relaxed (promise) decision version, where one needs to determine whether there is at leas tone point within distance r from the query (and report such a point), or whether there are no points within distance r(1+ε) from the query. According to an exemplary embodiment, to get a (1+ε)-approximate nearest neighbor, the above procedure needs to be repeated for a sequence of radii r₀, r₀(1+ε), . . . , rₘₐₓ, where r₀ and rₘₐₓ are the smallest and largest possible distances, respectively, between the query and a data point. The number of different radii may be limited (in terms of n) at the cost of increasing running time and storage requirement. In practice, however, it appears that even one value of r is sufficient to produce answers of good quality, as is evident from the experimental results described below.

The experiments described below focus on the use of InChI for identifying similar compounds. As a preliminary step, an annotator was developed to extract chemicals from unstructured text by using textual pattern recognition and generating InChI code. Using this annotator, 1,288,387 unique InChI's were extracted from the U.S. patent database (1976-2003). From this set, 80% were randomly selected for indexing, and the remaining 20% were used as a query pool.

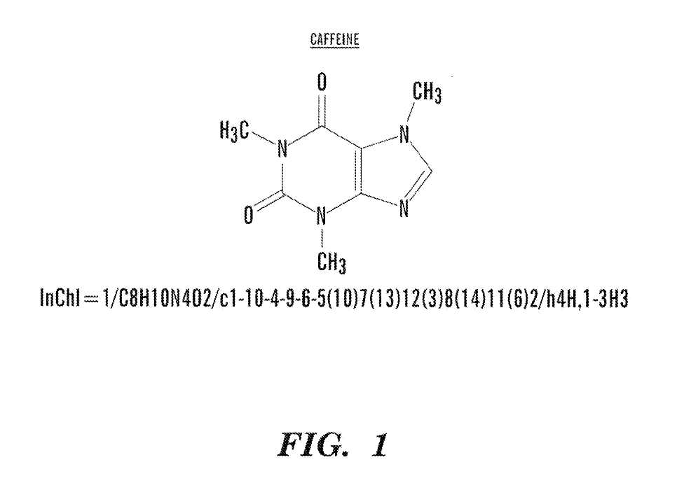

InChIs are unique for each molecule, and they include multiple layers that described different aspects of the molecule as depicted in FIG. 1. The first three layers (formula, connection and hydrogen) are considered the main layers and are the layers used for our experiments described herein. Using the main layers, unique features were extracted from a collection of InChI codes.

In the experiment, features were one to three character unique phrases. The formula, connection and hydrogen layers produced 296, 18384 and 11991 features, respectively. This makes the combined dimensionally of the dataset 30,671. On average, an InChI has a combined total of about 100 non-zero-valued features. Feature values are always nonnegative integers. In unary notation, where each of the three feature spaces is expanded by the maximum value of a feature in that space, the dimensionally explodes to 3,568,155, and the sparsity increases proportionally. Of course, this unary representation is implicit and need not be implemented explicitly.

Each InChI is processed by building for it three vectors which are then added to the respective vector space model. The results are three vector space models of size 30 MB, 138 MB and 64 MB for the formula (F₁), connection (F₂) and hydrogen (F₃) layers.

As mentioned earlier, each feature space Fⱼ defines a distance function Dⱼ by simply taking the l₁ metric between the corresponding vectors. Consequently, for every two molecules x and, y there are three distances defined between them, namely D₁(x,y), D₂(x,y) and D₃(x,y).

As pointed out earlier, the technique according to exemplary embodiments works with only one distance (radius) r. In contrast to conventional techniques, it cannot be defined as the 97- percentile of the distance from points to their nearest neighbor, because there are three distance functions. Instead, for each vector space Fⱼ, Rⱼ was calculated (by selecting a sample of 5400 InChI vectors from our query subset, finding the nearest neighbor under Dⱼ for each one of them, and taking the 97-percentile of the resulting distances. Then, distance Dⱼ(∵) was normalized by dividing it by the respective Rⱼ.

Using the number of hash functions k and the number of buckets l as described above, and using the parameters ε=1 (i.e., 2-approximation) and r=1, the following lists the computed value of Rⱼ for every feature space Fⱼ:

R₁=2, R₂=24, R₃=9.

Using several different weight vectors w′, the values for k, l, and R were selected to build l indices (hash tables). The selected weight vectors w′ are defined in the following table:

| w′ | F₁ | F₂ | F₃ |
|---|---|---|---|
| 1st | ¼ | ½ | ¼ |
| 2nd | ⅓ | ⅓ | ⅓ |
| 3rd | ⅕ | ⅗ | ⅕ |
| 4^{th} | 0 | ⅔ | ⅓ |
| 5^{th} | 0 | 1 | 0 |

This selection of weight vectors w′ is for experimental/illustrative purposes only. The idea is to focus on a single weight vector (the first one) and have a few other weight vectors at various degree of proximity from it.

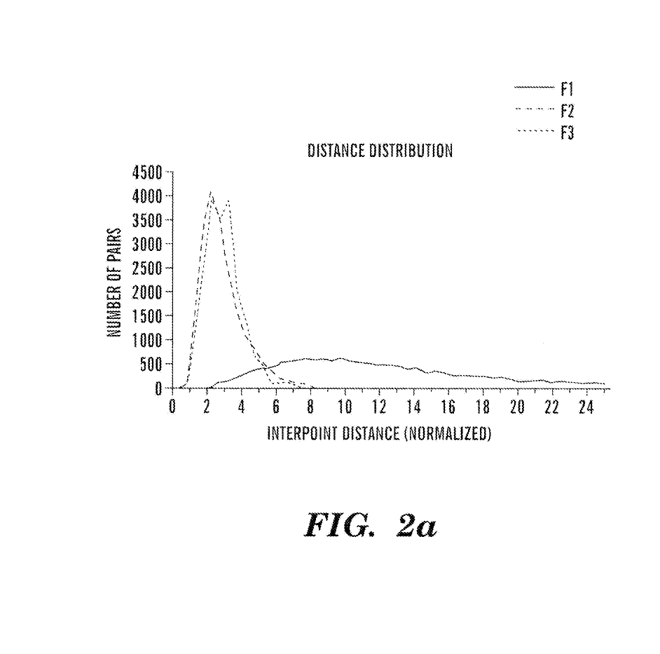

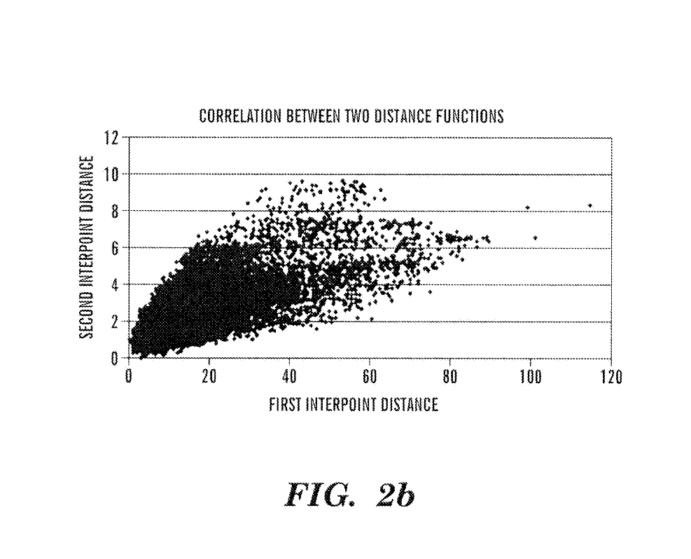

FIG. 2(a) illustrates the distribution of the (normalized) distances between pairs of points, separately in each layer. These results are based on a selecting a random sample of 200 points, and computing all the pairwise distances among them. As depicted in FIG. 2(a), the first distance function D₁ has a very different structure than the other two. Its average normalized distance is much larger, and it has a heavy tail, while the second distance function D₂ is highly concentrated.

FIG. 2(b) illustrates the correlation between D₁ and D₂, by plotting a tiny pixel at (D₁(x,y), D₂(x,y)) for every pair x,y in a random sample of 200 InChIs. It is easily seen that generally there is a positive correlation between the two distance functions, although there is considerable noise. The plots obtained in this way for other pairs of distances (D₁ vs. D₃; and D₂ vs. D₃) are omitted, as they appear qualitatively the same. To get a quantitative estimate of these correlations, the correlation coefficient between every pair of distance functions (in the sample of 200 points), summarized as follows:

| | Corr.Coeff. |
|---|---|
| D₁ vs. D₂ | 0.7027 |
| D₂ vs. D₃ | 0.3328 |
| D₁ vs. D₃ | 0.2434 |

A major benefit of the technique described herein is the relative size of the index compared to the overall vector space. In the implementation described herein, the objects (and their feature vectors) do not need to be replicated. Vectors are computed for each InChI and stored only in a single repository. Each index maintains the selection of k positions and a standard hash function for producing an actual bucket numbers. The buckets themselves are individual files on the file system, and they contain pointers to (or serial numbers of) vectors in the aforementioned single repository. This allows both the entire index as well as each bucket to remain small. This implementation is of course useful because this single large repository still fits in our computer's main memory (RAM).

During index creation, not all hash buckets are populated. Additionally, the number of data points per hash bucket may also vary quite a bit. In an experimental implementation, buckets were limited to a maximum of B=1000. Statistics regarding the number of buckets used, average bucket size (number of data points) and index memory usage can be seen in the following table of Index statistics for each w′:

| w′ | Buckets | MeanPoints | Size(kb) |
|---|---|---|---|
| (⅓, ⅓, ⅓) | 8337 | 123.63 | 898.1 |
| (¼, ½, ¼) | 8975 | 114.84 | 898.4 |
| (⅕, ⅗, ⅕) | 10499 | 98.17 | 987.6 |
| (0, ⅔, ⅓) | 19341 | 53.29 | 899.2 |
| (0, 1, 0) | 62542 | 16.48 | 899.6 |

As there is a lack of publicly available databases containing typical query points, a random subset of 20% of the database points was reserved to serve as queries. All experimental results were based on processing 400 queries that were selected at random.

As an accuracy measure, error was measured on a set of queries Q by defining the effective error as

$$E = \frac{1}{\vert Q \vert} {\sum }_{q = Q}^{ } \frac{{D}_{ALG} ( q )}{{D}^{*} ( q )} , \qquad ( 9 )$$

where D_{ALO}(q) denotes the distance from q to the answer returned by the query algorithm, and D′(q) is the distance from q to the optimal answer (as reported by a linear scan).

These two distances are computed with respect to the weighted distance function under investigation (i.e., weight vector w). For approximate K-NNS, the ratio between the closest point found and to the nearest neighbor was measured, the ratio of the 2nd closest one to the 2nd nearest neighbor was measured, and so on. Then the ratios were averaged. The miss ratio may be defined as the fraction of cases when less than K points were found.

Each experiment performed had two steps. In the first step, a weighted query was evaluated using a brute-force linear scan. For each query weight w, the weighted query distance was evaluated:

$$D ( x , y ) = {\sum }_{j = 1}^{m} {w}_{j} \cdot {D}_{j} ( x , y ) ,$$

where Dⱼ uses only the features in Fⱼ and includes the normalization by Rⱼ. The top 25 closest points were collected for evaluation. In the second step, the same query w was evaluated using the hashing-based algorithm proposed above. The first l indices built for a specific w′ were then used to process the query, providing a list of potential candidates. For each of these candidates, the weighted distance to the query point was computed, and the top 25 closest points were collected and evaluated according to the effective error defined above.

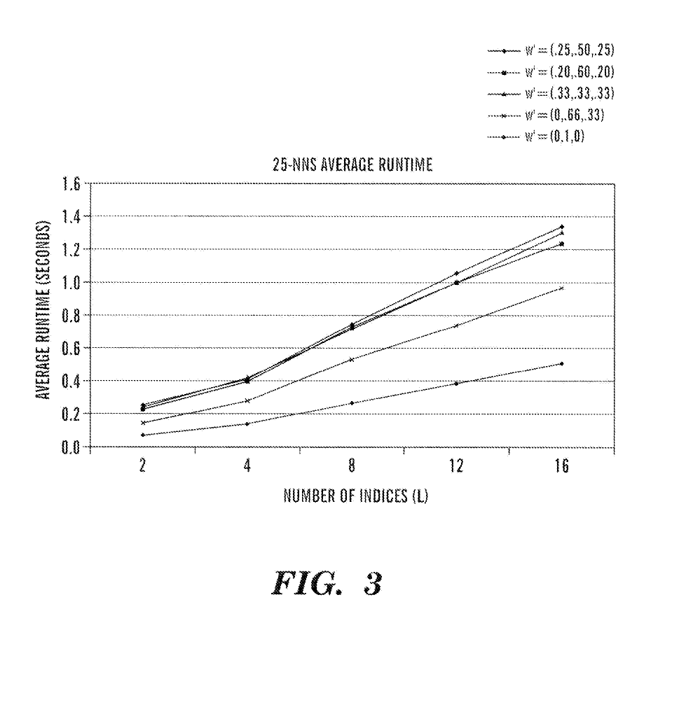

The computational efficiency runtime performance was evaluated for each w′ as well as for linear search. To negate any potential effects of operating system or filesystem caching, all tests were performed using an in memory data representation. While this is not feasible on extremely large data sets, for experimental purposes we had a sufficient amount of main memory (RAM). On average, the runtime of a linear scan was 22.4 seconds. Thus, the average runtime of the hashing-based algorithm, depicted in FIG. 3, was one to two orders of magnitude faster than linear scan, depending on the size of l. In FIG. 3, the results depicted were based on query weight w=(0.25, 0.50, 0.25). As expected, the efficiency degrades as l increases, since the runtime is roughly linear in l. Nevertheless, even at l=16 the runtime performance is significantly better than brute-force linear scan. The runtime of a linear scan algorithm that records the closest 25 points was measured, but it is clear that recording only the closest point would not change the results significantly.

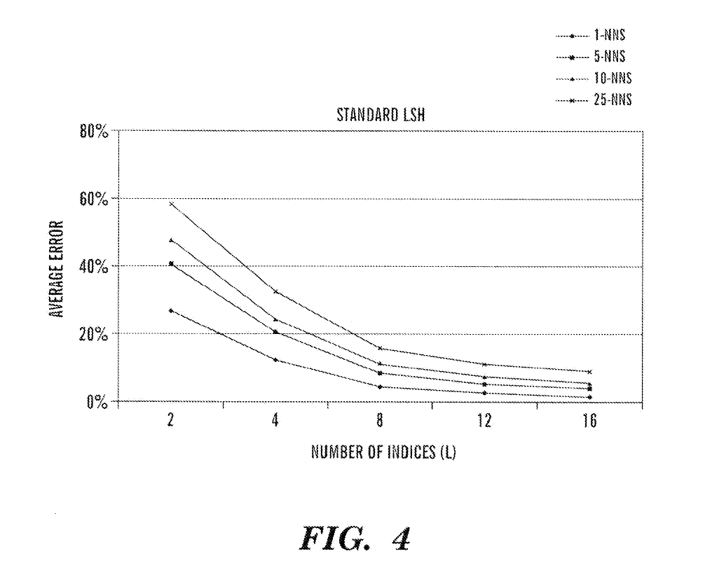

For calibration, a baseline experiment was run, where first the same weight vector was used in the preprocessing and in the query. The effective accuracy achieved in this experiment is given in FIG. 4, with results based on fixed preprocessing weights of w=(0.25, 0.50, 0.25). As expected, the error decreases as l increases, and the error in K-NNS increases with K. It is impressive to see that the smallest error, for 1-NNS with l=16, is only 2.8%. Furthermore, the effective error improves rapidly as l increases, although it remains nearly flat after l=10.

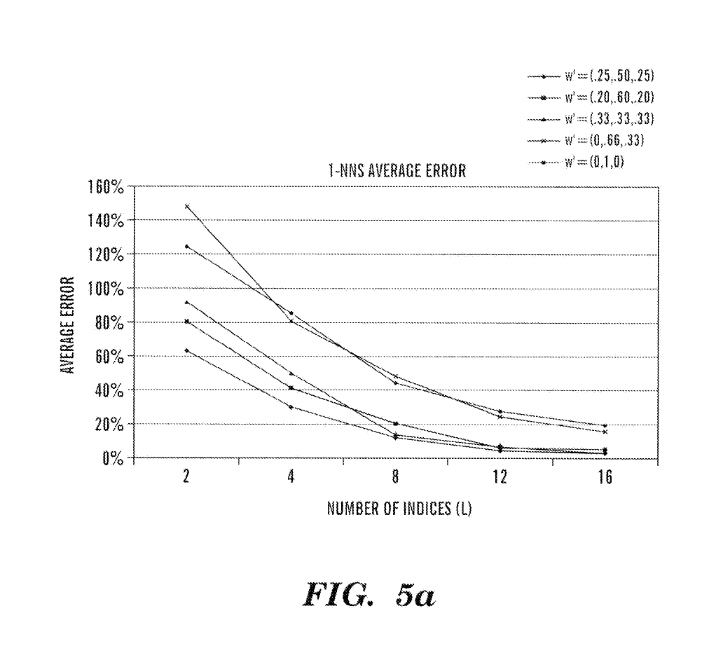

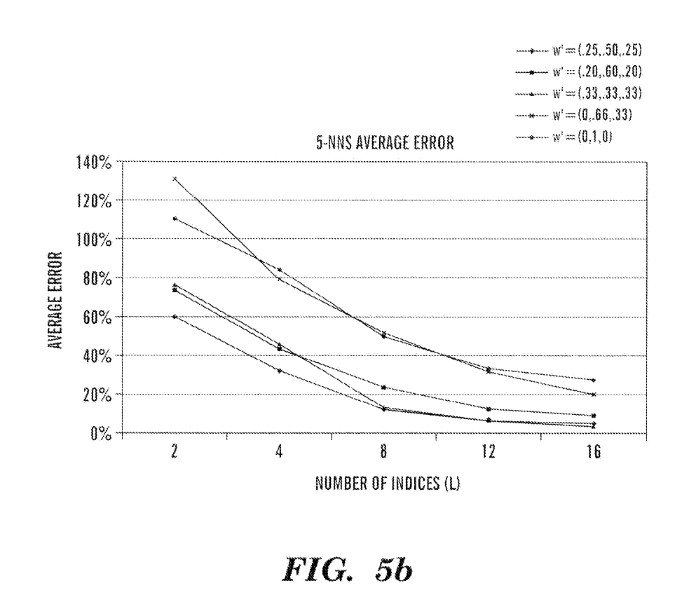

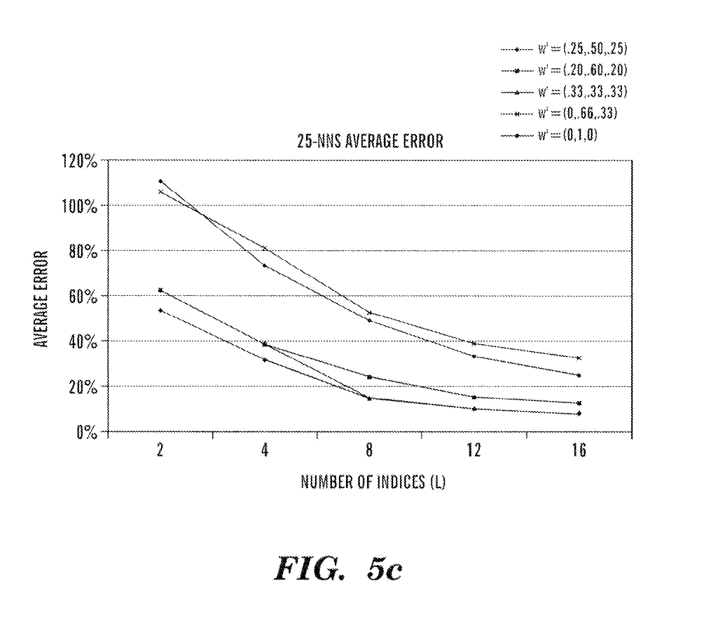

To better understand the accuracy of the technique proposed herein, many queries were evaluated with varying query weights. A random set of 400 queries was used with query weights w=(¼,½,¼) and varying hashing weights w′, as depicted in FIGS. 5(a), 5(b) and 5(c) for 1-NNS, 5-NNS, and 25. The best overall performing w′ in all three plots of 1-NNS, 5-NNS and 25-NNS was w′=(¼,½,¼) with the smallest error, at l=16, being 2.8%, 4.6% and 7.7%, respectively. It is interesting to examine the hypothesis that an approximate weight vector should give nearly as good results. It is easily seen that when w′ is reasonably close to w, namely w′=(0.2,0.6,0.2) and w′=(⅓,⅓,⅓), the effective error is almost as good as when w′=w, especially at the regime of large l. Additionally, it is important to note that there were no queries where a miss occurred in all indices.

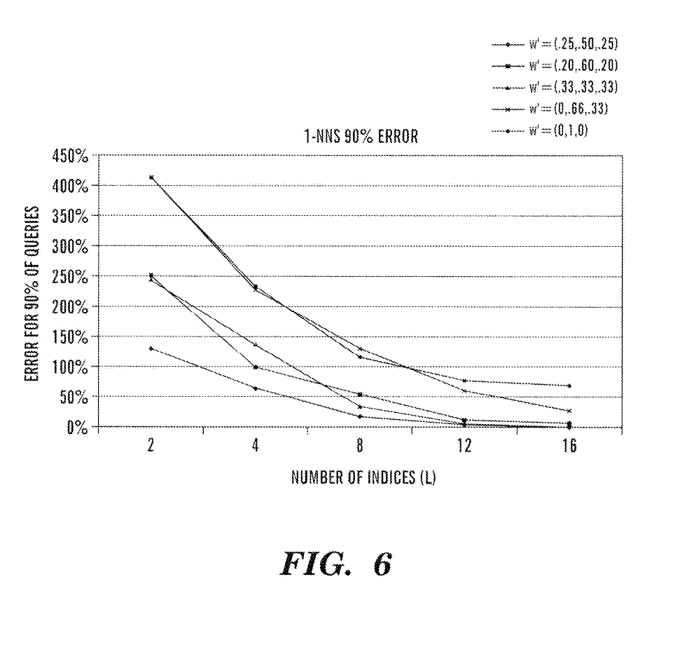

One may wonder whether only the average error is low (when w′is close to but different from w) or whether this is actually the case for most queries. For this purpose, an alternative definition of error was considered, which differs from that of effective error in that the 90 percentile (instead of the average) of the ratios obtained for 1-NNS of all queries q∈Q was used. The results of this analysis, depicted in FIG. 6, show that this is indeed achieved at the regime of large l, in which even weights w′ that are close to w perform well. In particular, at l=16 we get 0% error for w=w′ and for w=(⅓,⅓,⅓), and 4.4% error for w=(0.2,0.6,0.2).

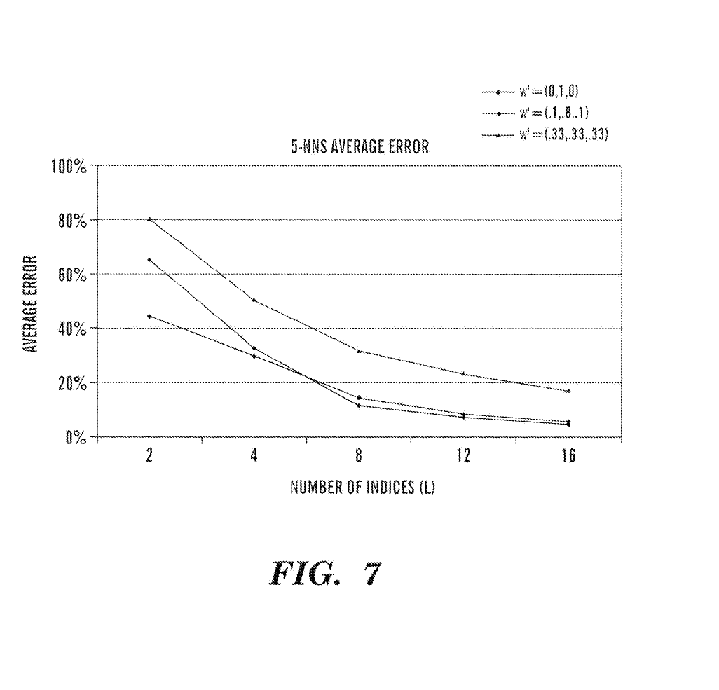

The opposite direction is investigated in FIG. 7. The preprocessing weight w′ was fixed at 0.25, 0.50, and 25, and it was measured how far the query weight w would wander off and still have low error. Again, it is seen that when the two weights are close to each other, the error is quite small (especially for large l), but the error can be quite large when the two weight vectors are far of each other. The results have been provided here for 5-NNS, but the results for 1-NNS and 25-NNS would be expected to be quite similar.

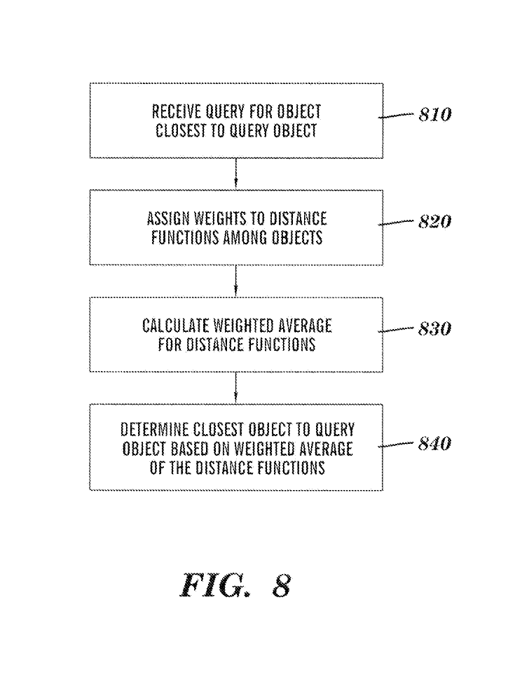

FIG. 8 illustrates an exemplary method for searching for similarities to a query object among multiple near-neighbor objects based on multiple criteria. The method begins at step 810 at which a query is received for an object closest to the query object. At step 820, weights are assigned by a user to distance functions among the multiple objects, each distance function representing a different criterion. Although shown as a separate step, step 820 may be performed at the same time as step 810. At step 830, the weighted average for the distance functions is calculated. At step 840, the closest object to the query object is determined based on the weighted average of the distance functions. Step 840 may include performing a hashing process using a hash function corresponding to a weight vector that is closest to the object.

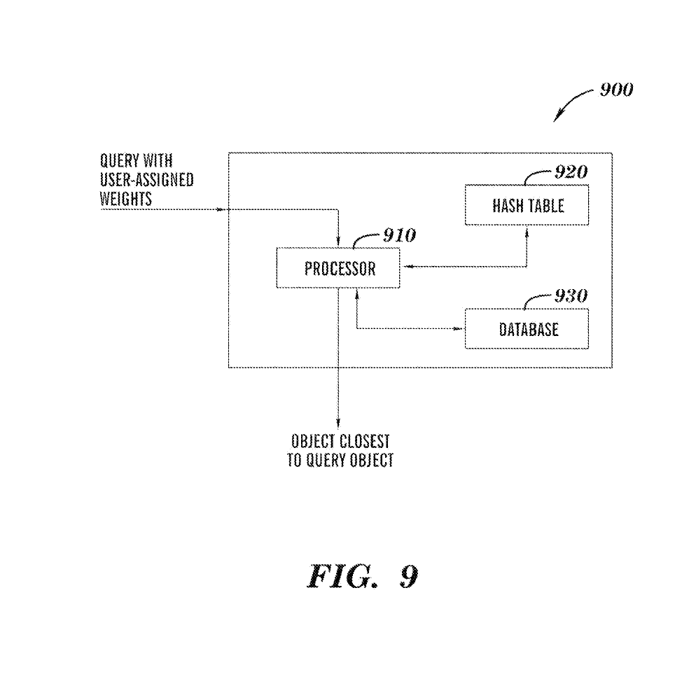

FIG. 9 illustrates an exemplary device for performing similarity searching as described above. It should be appreciated that the device shown is for illustrative purposes only and that similarity searching may be performed on any suitable device(s), depending on the needs of the user. The device in FIG. 9 may be a PC including a processor 910 for receiving a query for an object with weights assigned to distance functions by a user at the time of the query. The processor 910 calculates the weighted average for the distance functions in the manner described above. The processor 910 also finds a weight vector that is close to the object and retrieves a hash function from the hash table 920 that corresponds to the weight vector. Using the hash function, the processor retrieves candidates for the closest object to the query object from an object database 930. Although the database is shown as being included in the device 900, it should be appreciated that the database may be at least partially external to the device, contactable, e.g., by a connection, such as the Internet. Having retrieved candidate objects, the processor then determines the closest object to the query object, from the candidates retrieved from the database, based on the weighted average for the distance function.

According to an exemplary embodiment, a generalized paradigm for near neighbor search is provided that uses user-specified weights for different criteria and presents a hashing-based nearest neighbor search algorithm that accounts for these user-specified weights. A key idea underlying the technique described herein is that the user-specified weights can be used to affect the selectivity of the features used in the hashing step of the algorithm. The more weight the user puts on a specific feature, the more likely it is to be selected in the hashing process. The theoretical analysis shows that this method is guaranteed to an accuracy of (1+ε)-approximate nearest neighbor, in running time that is sublinear in n. For many large databases, where searches are performed in an interactive fashion, such improvements in the running time could be a necessity.

The experimental validation of the algorithm was on a large chemical database consisting of 1.3 million chemicals. Each molecule in the database was represented in a very high dimensional space (30,000 dimensions), which is sparse (around 100 features of non-zero valued). The experimental results show that the algorithm can adapt to a variety of weights, and validating our hypothesis that high accuracy can be achieved if the weights used for the hashing are close too the user-specified weights. In particular, when the user specifies feature weights that are non-uniform, our algorithm outperforms the standard LSH algorithm in terms of accuracy, while running at the same speed. Compared to a brute-force linear scan, the technique described herein is one to two orders of magnitude faster, and its effective error is in the low single-digit percent, even though the guaranteed accuracy is 2-approximation (ε=1). Overall, the empirical results are very consistent.

There may be interesting variations on the methodology described above. For example, the analysis of the algorithm according to exemplary embodiments technically proceeds by approximating the user-specified weight vector w with a suitable weight vector w′ taken from a small predetermined collection w′. A promising heuristic is to use several weight vectors from W′ and split the computational effort of l accesses to disk across the respective indices. Specifically, one can write w as a convex combination w=α₁w⁽¹⁾+. . . α₁w⁽¹⁾ and then use α,l indices that correspond to the weight w⁽¹⁾. This is called “heuristic” since it is not at all clear what circumstances guarantee that this algorithm performs well. Furthermore, there will likely be more than one way to write w as such a convex combination, and some are likely to be preferable.

Second, given the flexibility of the algorithm in dealing with different criteria, it may be beneficial to add to the structural InChI information additional features extracted from the body of the patent text. In fact, it may be desirable to exploit the rich structure of the patents corpus by augmenting the similarity search with full-text search over the patents and/or by leveraging the patents hyperlink structure.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for searching for similarities among multiple near-neighbor objects based on multiple criteria, comprising the steps of:
receiving a query for an object closest to a query object;
assigning weights to distance functions among the multiple objects at the time of the query, each distance function representing a different criterion, wherein the weights are assigned by a user, the objects are indexed and represented as high-dimensional feature vectors, and each distance function is a metric on a subset of features;
finding a weight vector that is close to the object and retrieving a hash function corresponding to the weight vector, wherein the user assigned weights affect the selectivity of the features used in the hashing process, and the more weight a user specifies for a specific feature, the more likely that feature is to be selected in a hashing process.
calculating the weighted average for the distance functions; and
determining the closest object to the query object within a given distance based on the weighted average for the distance functions and based on the hashing process using the retrieved hash function.

2-18. (canceled)
